(19) United States
(12) Patent Application Publication
(10) Pub. No.: US 2021/0117403 A1
(43) Pub. Date: Apr. 22, 2021

(54) STATELESS DATA PROCESSING

(71) Applicants: Ori MODAI, Herzliya (IL); Orit NISSAN-MESSING, Herzliya (IL); Yaron HAVIV, Herzliya (IL); Iguazio Systems Ltd., Herzliya (IL)

(72) Inventors: Ori Modai, Ramat Hasharon (IL); Orit Nissan-Messing, Hod Hasharon (IL); Yaron Haviv, Tel Mond (IL)

(21) Appl. No.: 16/494,275

(22) PCT Filed: Mar. 13, 2018
(86) PCT No.: PCT/US2018/022273

§ 371 Date: Sep. 13, 2019

Related U.S. Application Data
(60) Provisional application No. 62/470,679, filed on Mar. 13, 2017.
(60) Provisional application No. 62/541,808, filed on Aug. 7, 2017.

(51) Int. Cl. G06F 16/23; G06F 16/2455

(52) U.S. Cl. CPC G06F 16/2308; G06F 16/2455

(57) ABSTRACT

Systems and methods are disclosed for stateless data processing. In one implementation, multiple operations directed to an object are received. The operations are associated to generate a transaction sequence. Au atomic update of the object is performed in accordance with the generated transaction sequence.

### CROSS-REFERENCE TO RELATED APPLICATIONS

This application is related to and claims the benefit of priority to U.S. Patent Application No. 62/470,679, filed Mar. 13, 2017, and U.S. Patent Application No. 62/541,808, filed Aug. 7, 2017, each of which is incorporated herein by reference in its entirety.

### TECHNICAL FIELD

Aspects and implementations of the present disclosure relate to data processing and, more specifically, but without limitation, to stateless data processing.

### BACKGROUND

Various database technologies lock the state of stored objects to enable updates to be performed. Operations cannot be performed with respect to such objects while locked.

### SUMMARY

The following presents a shortened summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a compact form as a prelude to the more detailed description that is presented later.

In one aspect of the present disclosure, systems and methods are disclosed for stateless data processing. In one implementation, multiple operations directed to an object are received. The operations are associated to generate a transaction sequence. An atomic update of the object is performed in accordance with the generated transaction sequence.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates aspects of an example system, in accordance with an example embodiment.

FIG. 2 illustrates further aspects of an example system, in accordance with an example embodiment.

FIG. 3 illustrates an example scenario described herein, according to an example embodiment.

FIG. 4 illustrates an example scenario described herein, according to an example embodiment.

FIG. 5 illustrates an example scenario described herein, according to an example embodiment.

FIG. 6 illustrates an example scenario described herein, according to an example embodiment.

FIG. 7 is a flow chart illustrating a method, in accordance with an example embodiment, for stateless data processing.

FIG. 8 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to stateless data processing.

In order to perform an atomic transaction/sequence (e.g., a series of operations each of which must be performed in order for the transaction to complete), existing database technologies must first ‘lock’ the state of one or more stored objects. Having locked the relevant object(s), each operation in the atomic sequence (e.g., an update request) can be performed step-by-step, while retrieving the state of the object(s) in-between each update/change request. As a result of the referenced locking, the performance (and parallelism) of applications that perform operations and/or otherwise utilize such technologies can suffer (e.g., with respect to input/output operations per second (IOPs)). Additionally, the described framework can require utilizing or maintaining an additional state at the application, e.g., to save the state of the application and enable it to continue from where it stopped (e.g., in case a transaction/sequence fails prior to completion).

Additionally, existing technologies operate using various stored procedures. Such stored procedures can ‘pre-wire’ a server (or other such device) with the functional operation(s), which are triggered or initiated, e.g., by an update operation provided to the system. In contrast, the technologies described herein push or otherwise provide a sequence of update operations to the server. The server can then execute the received sequence.

Additionally, in certain implementations the described technologies provide the option to permutate the sequence of update operations, e.g., for each ‘command’ (which may, for example, include an aggregated sequence of update operations), as described herein. As also described herein, the described technologies enable a state of an object (whether before and/or after an operation, such as an update operation, is performed) to be referenced (e.g., with respect to other operations, etc.).

Accordingly, described herein in various implementations are technologies, including methods, machine readable mediums, and systems, that enable stateless data processing. In certain implementations, multiple operations directed to a stored object can be associated, encapsulated, etc., e.g., within a single command transaction sequence, or expression. Such operations (each of which may affect and/or depend upon the state of the object) can then be performed. In doing so, for example, multiple states (or changes thereto) associated with an object can be aggregated. The various operations can be performed and the result can be applied to the data object in a single command Doing so eliminates the need to lock the object while a transaction is being performed (as occurs in existing systems). Additionally, while existing technologies may need to save/maintain additional state(s) while a transaction is being performed (e.g., to enable rollback, etc., in a scenario in which a transaction fails), the technologies described herein do not require such additional states as the corresponding transaction is performed in a single operation. In doing so, the corresponding logic can be delegated from the application to the system, enabling the application to operate in a stateless manner and allowing it to be more robust with respect to failures, etc. of various operations to the object.

It can therefore be appreciated that the described technologies are directed to and address specific technical challenges and longstanding deficiencies in multiple technical areas, including but not limited to data processing, storage, and transactions. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

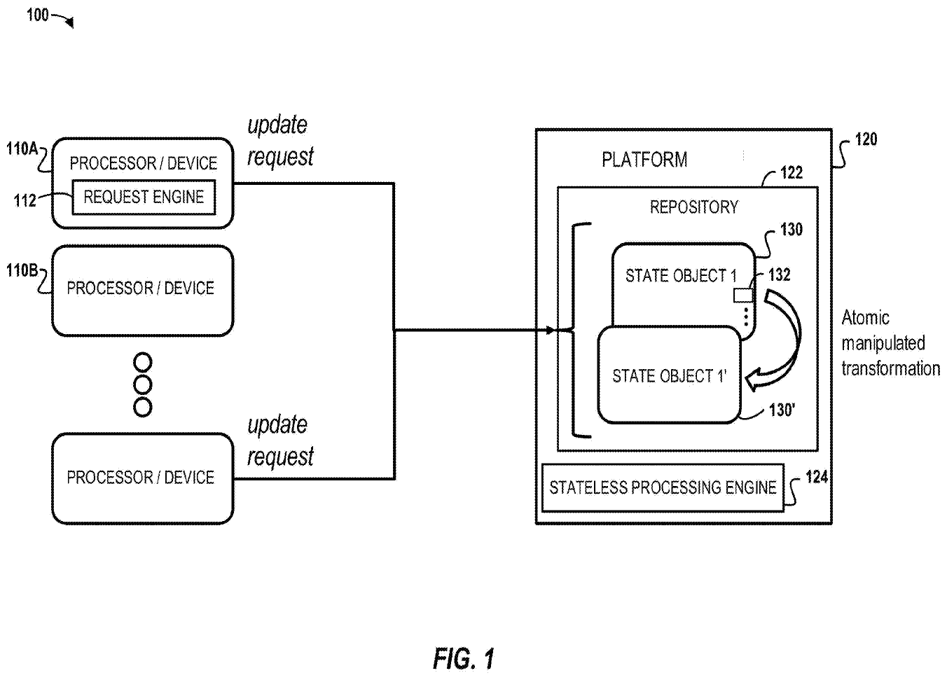

By way of illustration, FIG. 1 depicts an example system 100, in accordance with some implementations. As shown in FIG. 1, system 100 can include various clients (110A, 110B) such as devices, applications, processors, etc. as well as other systems, services (e.g., a “cloud” service), entities, etc., as described herein. Such clients, devices, etc. can be connected to and/or otherwise communicate or transmit information, data, etc. via various networks, connections, protocols, etc. (e.g., via the Internet).

In certain implementations, the referenced devices, applications, processors, etc. 110 can include or otherwise incorporate request engine 112. Request engine 112 can be a program, module, or set of instructions that configures/enables application, device, etc., 110 to perform various operations such as are described herein. For example, request engine 112 can configure device 110A to generate/provide an operation, update, etc. (and/or perform various other related operations/transformations) to object 130 within platform 120, as described herein. By way of illustration, device 110 can provide an update to a value or attribute of the object.

In certain implementations, the referenced device(s), processor(s), etc. can send multiple requests (e.g., update requests) to a data object (e.g., simultaneous requests originating from different devices). Such an object (e.g., object 130 as shown in FIG. 1) can be a file, record, database, etc. (or collection thereof) stored within a data/storage platform 120. Platform 120 can be, for example, a server computer, computing device, services (e.g., a “cloud” service), etc.

In certain implementations, platform 120 can include repository 122 and/or stateless processing engine 124. Repository 122 can be, for example, various storage resource(s) such as an object-oriented database, a relational database, memory, etc. with respect to which objects, data, files, content, messages, etc., such as those referenced herein, can be retrieved and/or stored. Stateless processing engine 124 can be a program, module, or set of instructions that configures/enables platform/server 120 to perform various operations such as are described herein. For example, stream management engine 124 can configure server 120 to update (and/or perform various other operations or transformations on) object 130 stored in repository 122, as described herein.

Using the described technologies, the referenced client(s), device(s), etc., can perceive, access, view, etc. the state of the object in either the state before (e.g., state 130) or after (e.g., state 130′) a particular update is performed. In such scenarios there is no intermediate state which such applications perceive, e.g., when an object is locked.

Further aspects and features of the described technologies (including system 100) are described in more detail below.

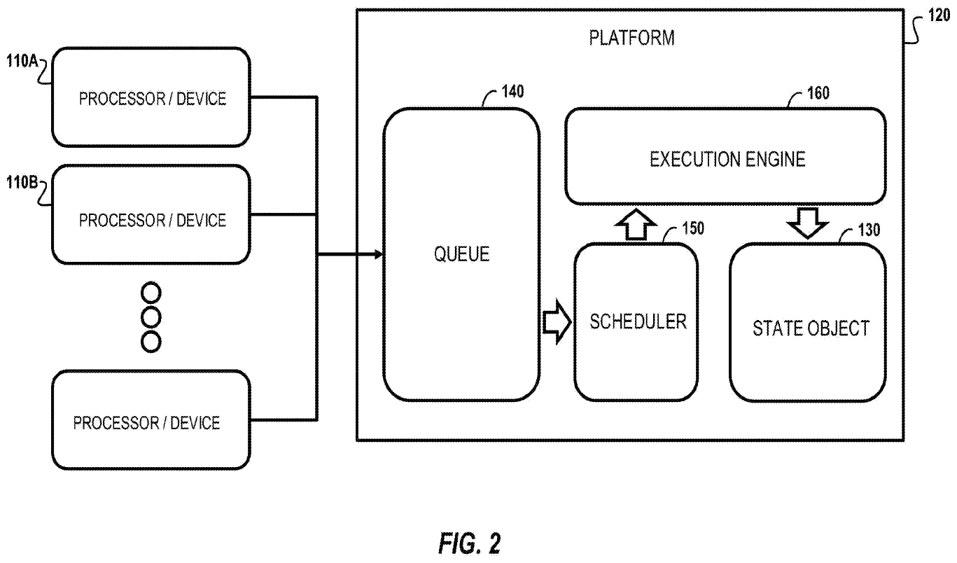

FIG. 2 depicts additional aspects of platform 120. As shown in FIG. 2, in certain implementations platform 120 can include queue 140 (which can be an element of repository 122 or stateless processing engine 124, as shown in FIG. 1). Queue 140 can be a request queue that receives and holds/stores multiple requests, messages, updates, etc. received by platform 120 (such as those originating from various clients, devices, etc.). In certain implementations, the requests received/stored in queue 140 can be provided to scheduler 150.

Scheduler 150 (which, in various implementations, may be an element of repository 122 or stateless processing engine 124, as shown in FIG. 1) can be a program, module, or set of instructions that configures/enables platform 120 to perform various operations such as are described herein. In certain implementations, scheduler 150 can sequence or otherwise arrange the various requests in queue 140 into a transaction sequence, expression, etc. (e.g., based on the sequence in which the requests were receive, their respective priorities, etc.) and provide the sequenced requests to execution engine 160. As described herein, the referenced sequence can include or otherwise reflect a sequence of statements to be performed in order such that, for example, one change may affect a sequential change within the same request. As also described herein, the referenced sequence, expression, etc. can sequence a set of changes with branching capabilities (e.g., if-then-else, etc.).

Execution engine 160 (which can be an element of stateless processing engine 124, as shown in FIG. 1) can be a program, module, or set of instructions that configures/enables platform 120 to perform various operations such as are described herein. In certain implementations, execution engine 160 can perform or execute the received requests (e.g., in accordance with the transaction sequence, expression, etc. defined by scheduler 150). In doing so, execution engine 160 can apply the resulting changes, updates, etc. to object 130 (e.g., as reflected in the transaction sequence of requests, updates, etc., defined by scheduler 150). In doing so, the described technologies can ensure that each update is performed atomically (such that, for example, multiple updates, requests, operations, etc., are to be performed collectively, whereby either all of the updates, operations, etc., are performed or the atomic update is rejected and none of the updates, operations, etc., are to be performed, e.g., in a scenario in which certain updates cannot be completed).

In certain implementations, the described technologies can further enable conditional state manipulation (such manipulations can include but are not limited to inserting data (e g, into an object, table, etc.), retrieving data, deleting data, and modifying data, e.g., within an object, database, etc.). For example, an update or update expression (e.g., as received from a device, processor, etc.) can be structured or otherwise associated with various conditional statements or properties. In certain implementations, such conditional statements can include if, then else, etc., conditions and such conditions can, for example, pertain to various attributes of an object, system attributes, access patterns, etc.

By way of illustration, a device, processor, application, etc. 110 can provide requests/operations that include conditional statements (e.g., that the operation should/should not be performed based on the state of a certain object, based on aspects of operation of the platform, etc.). For example, a request can include a conditional update to be performed upon determining that an object has (or does not have) a particular state, value, etc. Thus, an application can provide a sequence of statements/operations to be performed in-order such that one change may affect sequential change(s) within the same request.

Additionally, in certain implementations the described technologies can include or incorporate the use of various temporary attributes. For example, the described technologies can define or associate various objects with such attributes. A sequence of operations, requests, etc. can utilize such temporary attributes, e.g., with respect to the described state manipulation of an object but such temporary attributes may not persist (e.g., with the object) once such operations/updates are completed.

The described technologies can also enable the coordination of parallel operations, updates, etc. (which may originate from different devices, applications, etc.). For example, in certain implementations different applications may attempt to update the same object. In such scenarios, respective update operations (which may originate from different applications) can be conditioned on the state of an object. In doing so, such operations can be executed conditionally.

For example, a request to update an object can be structured such that it is conditioned on the value of the object (and/or on various attribute(s) within or associated with the object, such as attribute 132 as shown in FIG. 1). Examples of values or attributes of the object include but are not limited to: timestamps, version history, etc., of the object. Accordingly, an update/request (e.g., as generated by/received from a device, application, etc.) can be defined as being conditioned on the referenced value(s), attribute(s), etc. (e.g., performance of an update to the object is conditioned on the object having a certain timestamp or version attribute, etc.). In doing so, the described technologies (e.g., execution engine 160) can first determine whether the relevant value(s) of such object (or attribute(s) within/associated with the object) have changed (e.g., since the operation was initiated, thus no longer meeting the referenced condition) prior to updating the value of the object. Doing so can, for example, improve the efficiency and operation of the described systems, machines, and other technologies.

Additionally, in certain implementations multiple commands, operations, requests, etc. (e.g., updates to an object) can be chained or otherwise associated with respect to one another. For example, various state attributes of an object can be updated (e.g. asynchronously) based on/in response to the performance of an update operation. Such second (or subsequent) update(s) (whose performance occurs based on/in response to a first/previous update, operation, etc.) can reflect, for example, the value of an object before and/or after an update is performed. Other operations (e.g., messages, notifications, alerts, etc.) can also be initiated or performed in a comparable manner.

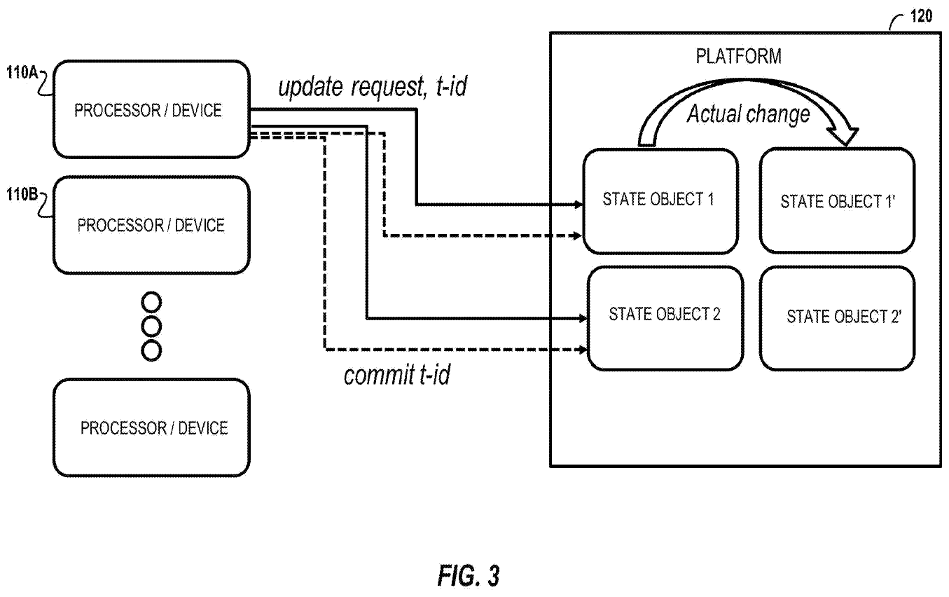

Further aspects of the described technologies are depicted in FIG. 3. As shown in FIG. 3, an update request can be received and/or generated by a processor, device, application, etc. 110A. In certain implementations, such an update request can pertain to multiple objects (e.g., ‘state object 1’ and ‘state object 2’ within data/storage platform 120, as shown in FIG. 3). Processor, device, etc. 110A can be configured to communicate or otherwise coordinate with platform 120, e.g., to verify that the referenced operation/update (which may pertain to multiple objects) is possible. For example, platform 120 (e.g., via stateless processing engine 124) can return a “ready” indication, message, etc. to the processor, device, etc. 110A, reflecting that the operation can now be performed. It should be understood that in the described the state of the referenced object (e.g., ‘state object 1,’ as shown in FIG. 3) is not yet changed (and other applications may thus change the object at this time).

In response to receiving the referenced indication from platform 120, device, processor, application, etc. 110A can generate and/or provide a commit request, e.g., with respect to the update/operation with respect to which the update request was previously performed. In response to such a commit request, the corresponding update request can be performed at the data platform (e.g., with respect to the corresponding objects). In doing so, various associated condition(s) associated with the operation can be checked against the object(s) (which, as noted, may have been updated by other operations) and the actual change of the state of the object(s) can be performed. It can be appreciated that doing so can provide atomicity with respect to the change of each object (as the referenced update requests are only performed upon receiving a subsequent commit request from processor, device, etc., 110A).

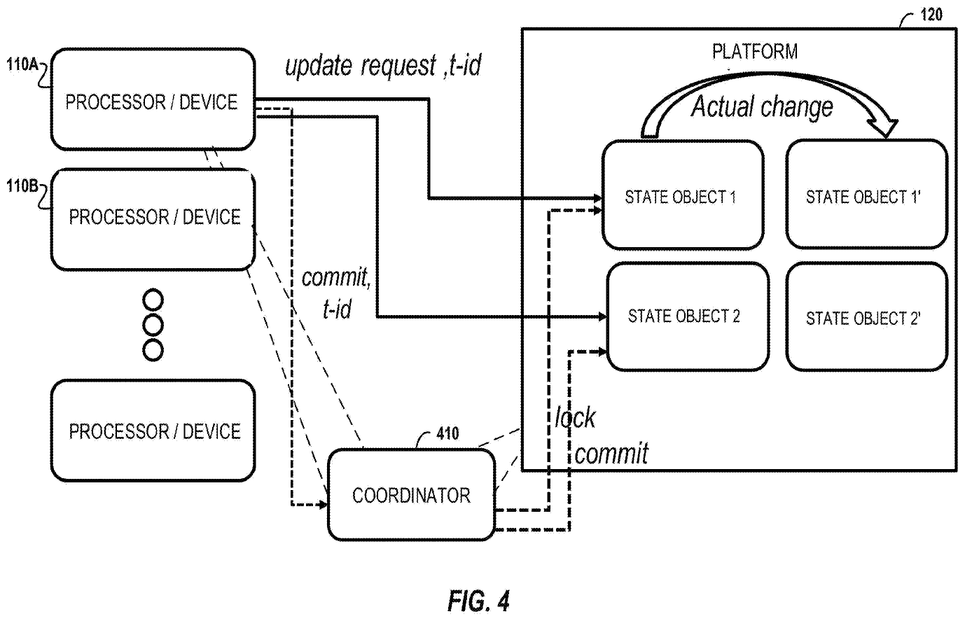

Further aspects of the described technologies are depicted in FIG. 4. As shown in FIG. 4, an update request can be provided by/received from device, processor, etc., 110A and platform 120 can determine/verify that it is possible to perform such a request (e.g., with respect to the corresponding object(s)), and return a ‘ready’ indication. As described above (with respect to FIG. 3), the object state is not yet changed, and other applications may change the object(s) at this time.

Subsequently, a commit request can be provided/received (e.g., with respect to the referenced operations), as described above with respect to FIG. 3. In response to such a commit request, coordinator 410 (which can be an application, module, etc., that may be deployed/implemented within processor, device, etc., 110A or platform 120) can issue a lock request (e.g., with respect to the various object(s) associated with the transaction) and further issue a commit request to the various objects in the transaction. The relevant update request can then be performed, with corresponding conditions being checked against the object(s) (which, as noted, may have been updated by other operations). In doing so, coordinator 410 can provide isolation because the object is locked (such that other processors attempting to access or change the object will see either the state of the object before or after the update).

In certain implementations, the described technologies can be further configured to enable multiversion concurrency control (MVCC) functionality/support with respect to the data object(s) described herein, and/or portions thereof. In doing so, MVCC capabilities can be provided with respect to such objects even in scenarios in which the database as a whole (within which such objects are stored) does not provide MVCC functionality.

In one example, the object definition of such an object can be structured (e.g., with respect to creation time/table schema) with information reflecting which portion(s) of the object MVCC support/functionality may be relevant/applicable to. As noted, in certain implementations MVCC support may be relevant for an entire data object, while in other implementations MVCC may only be relevant for a portion, subset structure, etc. of the object. Additionally, in certain implementations the described technologies can enable queries to be processed based on a transaction ID provided (e.g., with or in relation to the query).

By way of illustration, the technologies described/depicted herein can be configured to process an atomic MVCC delegation. In certain implementations, in order to maintain the version control, an attribute or additional object can be added to/associated with the object, in order to manage the version's transaction identifier (“ID”). Such an attribute can be maintained as a system attribute. For example, an array of size N of IDs can be maintained with pointers to the relevant offset within the per specific version area. It should be understood that ‘N’ (here, referring to the number of versions to maintain for the object) can be provided or defined at the time the object is created and/or or by associated/related schema. It should also be understood that ‘N’ may be extended, reduced, etc., e.g., during the lifetime of the associated object. For example, in certain implementations aspects of a definition of an object (e.g., creation time, table schema, etc.) can be structured with information reflecting which portion of the object may need or is to be associated with to be MVCC (e.g., the entire object, only a subset structure, etc.). In certain implementations, such an object and/or its definition can include, reflect, and/or otherwise be associated with a monotonic transaction ID and/or update expression(s) with conditions, e.g., regarding the last or previous transaction ID(s).

It can be appreciated that certain attributes (e.g., portions or aspects of an object) that are shared or otherwise remain consistent across multiple versions of an object may not necessarily require MVCC capabilities. Accordingly, the described technologies can be configured to identify such attributes and treat such attributes as “regular” attributes which are otherwise not affected by the described version management operations. Doing so can, for example, increase processing efficiency and performance and improve operation of the described machines, systems, services, etc. (e.g., by employing the described capabilities where advantageous while not applying them where they are less likely to be relevant).

Other attributes (e.g., portions of an object that change across multiple versions of the object) can be maintained with the described version control features. For example, the described technologies can hold or maintain a per-version specific area (of the object) for such attributes. Such an area can maintain a record of the per-version value of the referenced attribute. It should be understood that the respective per-version values for the referenced attributes can be maintained in various structures such as by using naive array, slabs, or other such mechanisms.

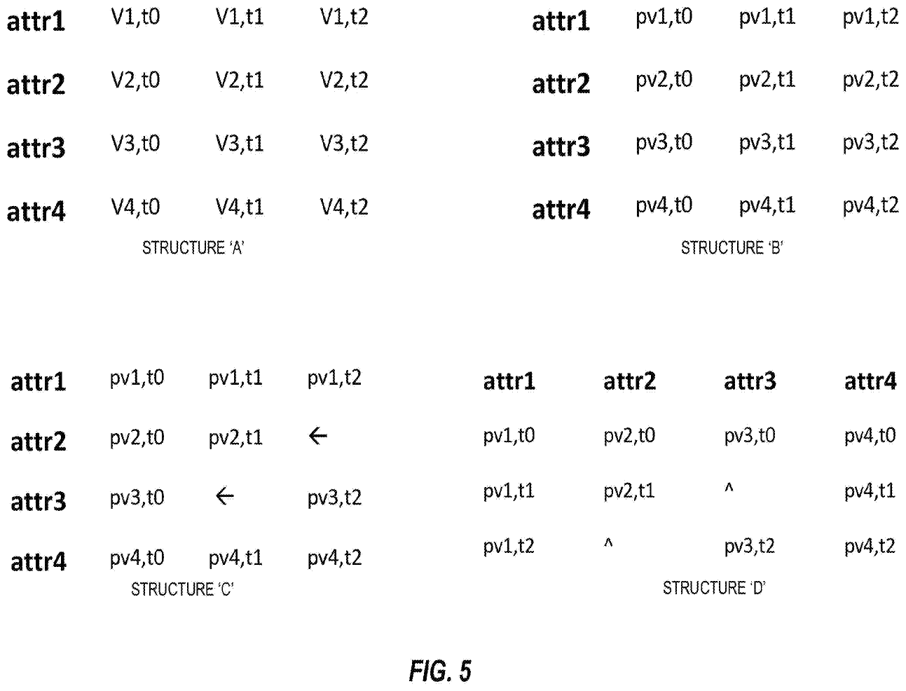

Various example implementations of the described technologies are depicted in FIG. 5. As shown in FIG. 5, various structures (structures ‘A’-‘D’) can be used to implement version control with respect to the refenced attributes of an object.

For example, structure ‘A’ as shown in FIG. 5 depicts an example implementation of the described version control functionality utilizing a ‘naïve’ structure. In such a structure, each respective row can hold its own set of values (‘V’) in place (e.g., for various attributes, such as ‘attr1,’ ‘attr2,’ etc.), and the values can be accessed via an index. It should be understood that, in certain implementations, the depicted structure can be transposed (such that values from the same version are arranged in sequence).

By way of further example, structure ‘B’ as shown in FIG. 5 depicts an example implementation of the described version control functionality utilizing a dereferenced structure. As shown, each row (corresponding to an attribute, such as ‘attr1,’ ‘attr2,’ etc.) can hold its own set of values referenced by pointer (‘pv’) or an indirection. The values can be accessed via an index (which may also entail dereferencing the value). Among the benefits of such a structure are that values (of the referenced attribute(s)) can be saved once and shared between versions (e.g., in instances when the value doesn't change). Additionally, in certain implementations, the data can be held in place (e.g., as in the naïve structure), such as in cases where the data held in the attribute is small.

By way of yet further example, structure ‘C’ as shown in FIG. 5 depicts an example implementation of the described version control functionality utilizing a sparse dereferenced structure. As shown, such a structure can function in a manner comparable to the dereferenced structure (structure ‘B’) described above, with the option to symbolize that a cell is equal to the previous version (indicated with an ‘arrow’ in structure ‘C’). Among the benefits of such a structure are that the structure can reduce the need to update versioned attributes (e.g., on every new version) (thereby reducing processing overhead, increasing efficiency, and improving operation of the described machines, platforms, technologies, etc.).

Structure ‘D’ as shown in FIG. 5 depicts an example implementation of the described version control functionality utilizing a sparse transposed dereferenced structure. As shown, such a structure can function in a manner comparable to the sparse dereferenced structure (structure ‘C’) described above, where the values are held by version and not by attribute. Additionally, in certain implementations the referenced structure can further hold/include data, information, etc. (e.g., hints or other such information, depicted with a “\hat{ }” in FIG. 5) related to the actual values (e.g., in order to optimize read vs. write operations). Among the benefits of such a structure are that the structure can provide the ability to extract an entire version in a single operation. Using this structure/approach can also enable the values from the same version to be held in sequence (thus accelerating the dereference operation).

As noted above, in certain implementations the referenced transaction ID can be provided by clients (devices, etc.) or automatically assigned by the platform/system (e.g., using a monotonous clock). In cases where the transaction ID is provided by clients, a monotonic ID can be assigned. To do so, in certain implementations the transaction assignment can be delegated to a dedicated object (which can be allocated per table or per higher level entity/domain) Another approach for assigning transaction IDs is by the use of a central or distributed coordinator device, application, service, etc. It should be noted that multiple objects can be updated using the same ID (for transaction identification), thus providing cross-object transactions. It should also be understood that the described transaction IDs may not necessarily be consecutive.

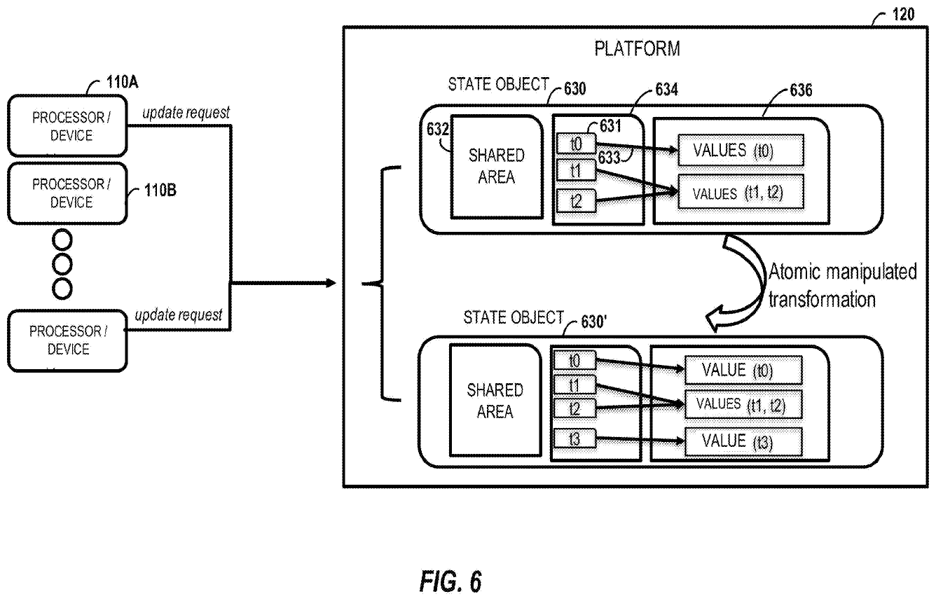

Further aspects of the described technologies are shown in FIG. 6. As shown in FIG. 6, the referenced state object 630 can include shared area 632. Such a shared area can correspond to/include attributes which do not change (e.g., across multiple versions of the object, as described above). The object 630 can further include an array 634 which include transaction IDs 631 (t0, t1, etc.) and pointer(s) 633 to a location (e.g., within a repository, database, etc.) where such corresponding values are actually stored (636). Transformation of the object can also be performed as depicted in FIG. 6 and described herein.

The structure described and depicted herein enables direct access to the current version of the object/attribute, e.g., by simply accessing the value pointed by the “current” version index.

Various operations can be utilized to enable MVCC functionality in conjunction with the described/depicted structures (e.g., to select, access, query for, etc. another version of an object). One such operator can provide the index of a given transaction ID range. For example, the described technologies can provide the ability to query transparently for a previous state of the object. In doing so, MVCC operation can be transparently supported within an object. For example:
indexof(arr, value)
   if arr[0]>value return−1 (meaning not in the array)
   else return i for which arr[i−1]>=value and arr[i]<value

The depicted operator can be extended to support a rotating window, e.g., with the addition of a dedicated attribute for pointing to the oldest version index in the array (and replacing the edge condition accordingly). Additionally, in certain implementations a similar operator can provide the location (pointer) of a given ID range (e.g., instead of the index).

It should be understood that when retrieving the object's state, the ‘current’ version can be retrieved (in addition to shared area), e.g., unless the request specifies otherwise. In doing so, the described objects can be interacted with/accessed without specifying additional parameters (e.g., transaction IDs, etc.), e.g., in scenarios in which the value of the object is requested without specific regard for transactional aspects of the object. As noted, in such scenarios the ‘current’ version of the object will be provided. For example, the last/most recent version of the respective values, together with the shared values, can be utilized together to present/provide the current version of the object (e.g., in response to a request).

Additional operators that may be supported can include a TransactionIdOf(condition) operator (or using a specialized operator indication such as [*]). Such an operator can return the transaction ID of the object when the condition was held on it (and, for example, −1 if the condition does not meet any of the saved versions).

Additional example operators can include: TimeLine(attribute, range). Such an operator can provide the values a given attribute holds during the provided/specified transaction range. For example, the described technologies can provide the ability to query the state of an object at a previous state. In doing so, MVCC operation can be transparently supported within an object, as described herein. Moreover, in certain implementations the described technologies can enable the described MVCC description to be utilized for implementing time series metrics (e.g., the different values a sensor holds or outputs during a time range).

Further example operations can also enable automatic versioning. For example, by defining the time interval for each version, upon a change in interval the described technologies can create/generate a new version of the object that can hold all the changes to the “per specific attributes” within that version.

By way of further example, the described technologies can also enable automatic versioning with operation. Doing so can, for example, define the interval and/or the operation type to be performed, e.g., per each change to a given version. By way of illustration, the minimum value of an attribute can be held across all changes made to that attribute within a given version. For example, in a scenario in which the interval is 10 seconds, and the operation is ‘+’—update(s) to the attribute occurring in time [0,10) can be accumulated into version 1 of the object/attribute, while updates(s) occurring in time [10,20) can be automatically accumulated into version 2.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

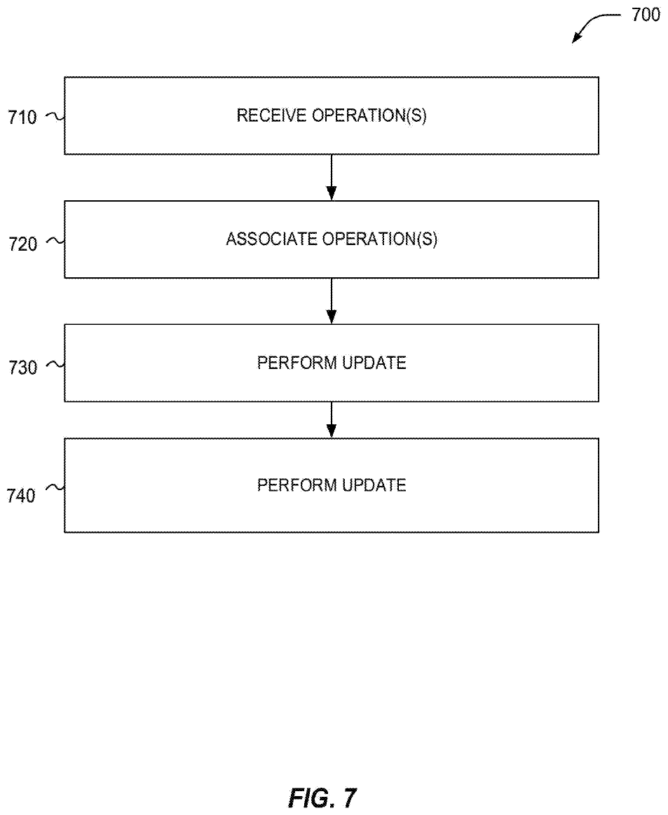

FIG. 7 is a flow chart illustrating a method 700, according to an example embodiment, for stateless data processing. The method is performed by processing logic that can comprise hardware (circuitry, dedicated logic, etc.), software (such as is nm on a computing device such as those described herein), or a combination of both. In one implementation, the method 700 is performed by one or more elements depicted and/or described in relation to FIGS. 1-6 (including but not limited to processor, device, application, etc., 110, request engine 112, platform 120, execution engine 160, etc.), while in some other implementations, the one or more blocks of FIG. 7 can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 710, or more operations can be received (e.g., by platform 120, processing engine 124, etc.). In certain implementations, such operations may originate from device, processor, etc., 110 (e.g., as generated by request engine 112) and may be directed to an object (e.g., updates to a state of an object stored in the platform), as described herein. Additionally, in certain implementations such operations can be conditional operations that may depend upon the current and/or previous state of an object (and/or other items, aspects, etc., as described above). Additionally, in certain implementations such operations can include a query for a previous state of an object, attribute, etc., as described herein.

As also described herein, in certain implementations multiple operations can be received from different sources (e.g., one or more operations from device, processor, etc., 110A and one or more other operations from device, processor, etc., 110B). Additionally, in certain implementations the operations described herein may be directed to different objects.

It should also be noted that, in certain implementations, the object(s) referenced herein can include or otherwise incorporate various elements, features, components, etc., such as a shared area (e.g., shared area 632 of object 630 as shown in FIG. 6 and described herein) and an array (or other such structure) of transaction identifiers (e.g., array 634 of identifier(s) 631). As described in detail herein, such a shared area can include or reflect attributes that remain consistent across multiple versions of the object, and such an array of transaction identifiers can include or reflect pointers, etc., (e.g., pointer 633) to various stored attributes (e.g., of an object). As described in detail herein, in certain implementations such elements can enable multiversion concurrency control (MVCC) functionality/support with respect to the referenced object(s). Additionally, as described herein, such attributes can correspond to or reflect various previous version(s) of an object and/or aspects thereof.

At operation 720, the operation(s) (e.g., those received at operation 710) can be associated. In doing so, a transaction sequence or expression can be generated. For example, in certain implementations multiple operations can be encapsulated, combined, sequenced, e.g., into a single command, as described herein. Additionally, as described herein, in certain implementations an update resulting from one operation within such a transaction sequence can affect, impact, etc. update(s) resulting from other operation(s) within the transaction sequence. Accordingly, the transaction sequence, expression, etc. can reflect various ways in which an update associated with one operation within the transaction sequence can affect or impact other updates, such as those associated with other operation(s) within the transaction sequence (e.g., those that may be conditional on the state of the object, etc.).

Additionally, as described herein, in certain implementations one or more of the referenced operations can utilize various temporary attribute(s) with respect to the object. Such temporary attribute(s) can be those that do not persist with the object after performance/completion of the update, as described here.

At operation 730, an update of the object can be performed. In certain implementations, such an update (e.g., an atomic update) can be performed in accordance with a transaction sequence, expression, etc. (e.g., as generated at operation 720). In doing so, for example, a single operation can be performed with respect to the object based on results of multiple operations included/associated within the referenced transaction sequence. Additionally, in certain implementations the referenced update can be an atomic update pertaining to multiple objects, as described herein.

At operation 740, the state of another object can be updated, e.g., based on the updating of the first object (e.g., at operation 730), as described herein. Additionally, in certain implementations such updating can include performing an atomic update of another object in accordance with the transaction sequence, expression etc. (e.g., as generated at operation 720) and based on the update of the object (e.g., at operation 730).

While many of the examples described herein are illustrated with respect to single server and/or individual devices, this is simply for the sake of clarity and brevity. However, it should be understood that the described technologies can also be implemented (in any number of configurations) across multiple devices and/or other machines/services.

It should also be noted that while the technologies described herein are illustrated primarily with respect to stateless data processing, the described technologies can also be implemented in any number of additional or alternative settings or contexts and towards any number of additional objectives. It should be understood that further technical advantages, solutions, and/or improvements (beyond those described and/or referenced herein) can be enabled as a result of such implementations.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described and illustrated herein are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

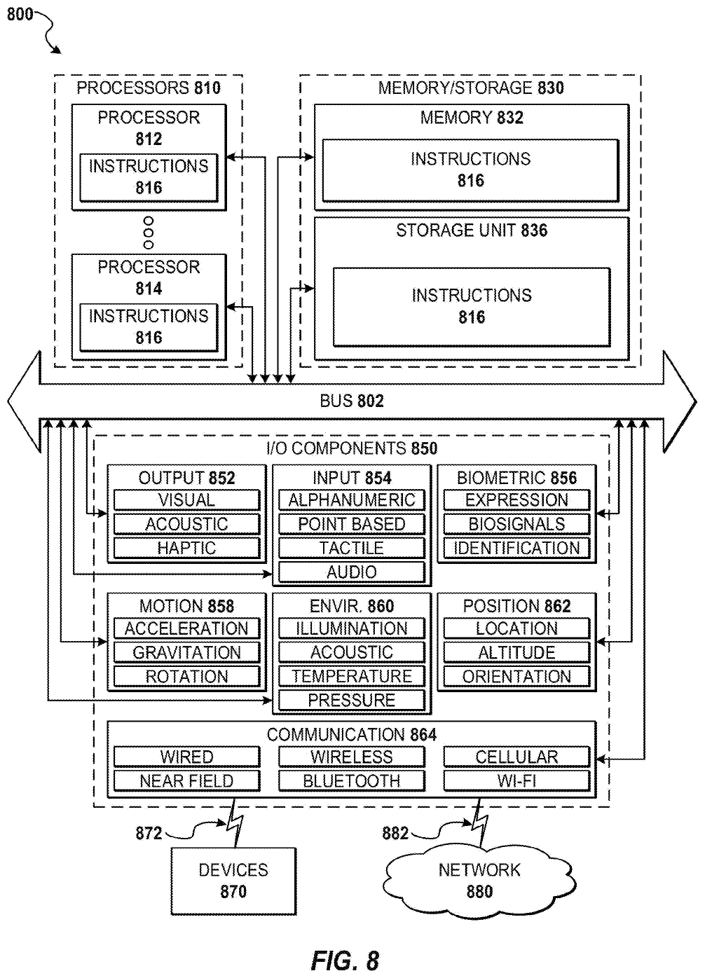

FIG. 8 is a block diagram illustrating components of a machine 800, according to some example implementations, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein can be executed. The instructions 816 transform the general, non-programmed machine into a particular machine programmed to carry out the described and illustrated functions in the manner described. In alternative implementations, the machine 800 operates as a standalone device or can be coupled (e.g., networked) to other machines. In a networked deployment, the machine 800 can operate in the capacity of a server machine or a client machine in a server-client network environment, or as a peer machine in a peer-to-peer (or distributed) network environment. The machine 800 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 can include processors 810, memory/storage 830, and I/O components 850, which can be configured to communicate with each other such as via a bus 802. In an example implementation, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 812 and a processor 814 that can execute the instructions 816. The term “processor” is intended to include multi-core processors that can comprise two or more independent processors (sometimes referred to as “cores”) that can execute instructions contemporaneously. Although FIG. 8 shows multiple processors 810, the machine 800 can include a single processor with a single core, a single processor with multiple cores (e.g., a multi-core processor), multiple processors with a single core, multiple processors with multiples cores, or any combination thereof.

The memory/storage 830 can include a memory 832, such as a main memory, or other memory storage, and a storage unit 836, both accessible to the processors 810 such as via the bus 802. The storage unit 836 and memory 832 store the instructions 816 embodying any one or more of the methodologies or functions described herein. The instructions 816 can also reside, completely or partially, within the memory 832, within the storage unit 836, within at least one of the processors 810 (e.g., within the processor's cache memory), or any suitable combination thereof, during execution thereof by the machine 800. Accordingly, the memory 832, the storage unit 836, and the memory of the processors 810 are examples of machine-readable media.

As used herein, “machine-readable medium” means a device able to store instructions (e.g., instructions 816) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine (e.g., processors 810), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 850 can include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 can include many other components that are not shown in FIG. 8. The I/O components 850 are grouped according to functionality merely for simplifying the following discussion and the grouping is in no way limiting. In various example implementations, the I/O components 850 can include output components 852 and input components 854. The output components 852 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 850 can include biometric components 856, motion components 858, environmental components 860, or position components 862, among a wide array of other components. For example, the biometric components 856 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 can include acceleration sensor components (e.g., accelerometer), gravitation sensor components, rotation sensor components (e.g., gyroscope), and so forth. The environmental components 860 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 862 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 850 can include communication components 864 operable to couple the machine 800 to a network 880 or devices 870 via a coupling 882 and a coupling 872, respectively. For example, the communication components 864 can include a network interface component or other suitable device to interface with the network 880. In further examples, the communication components 864 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 can be another machine or any of a wide variety of peripheral devices (e.g., a peripheral device coupled via a USB).

Moreover, the communication components 864 can detect identifiers or include components operable to detect identifiers. For example, the communication components 864 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 864, such as location via Internet Protocol (IP) geolocation, location via Wi-Fi® signal triangulation, location via detecting an NFC beacon signal that can indicate a particular location, and so forth.

In various example implementations, one or more portions of the network 880 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 880 or a portion of the network 880 can include a wireless or cellular network and the coupling 882 can be a Code Division Multiple Access (CDMA) connection, a Global System for Mobile communications (GSM) connection, or another type of cellular or wireless coupling. In this example, the coupling 882 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UNITS), High Speed Packet Access (HSPA), Worldwide Interoperability for Microwave Access (WiMAX), Long Term Evolution (LIE) standard, others defined by various standard-setting organizations, other long range protocols, or other data transfer technology.

The instructions 816 can be transmitted or received over the network 880 using a transmission medium via a network interface device (e.g., a network interface component included in the communication components 864) and utilizing any one of a number of well-known transfer protocols (e.g., HTTP). Similarly, the instructions 816 can be transmitted or received using a transmission medium via the coupling 872 (e.g., a peer-to-peer coupling) to the devices 870. The term “transmission medium” shall be taken to include any intangible medium that is capable of storing, encoding, or carrying the instructions 816 for execution by the machine 800, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform operations comprising:
receiving a plurality of operations directed to an object;
associating the plurality of operations to generate a transaction sequence; and
performing an atomic update of the object in accordance with the transaction sequence.

2. The system of claim 1, wherein at least one of the operations adjusts a state of the object.

3. The system of claim 1, wherein at least one of the operations comprises a conditional operation that is dependent upon the state of the object.

4. The system of claim 1, wherein an update resulting from a first operation within the transaction sequence affects an update resulting from a second operation within the transaction sequence.

5. The system of claim 1, wherein at least one of the operations utilizes a temporary attribute with respect to the object.

6. The system of claim 5, wherein the temporary attribute does not persist with the object after performance of the atomic update.

7. The system of claim 1, wherein performance of at least one of the operations is dependent upon a state of the object.

8. The system of claim 1, wherein performance of at least one of the operations is dependent upon a previous state of the object.

9. The system of claim 1, wherein at least one of the operations comprise a query for a previous state of the object.

10. The system of claim 1, wherein the memory further stores instructions for causing the system to perform operations comprising updating a state of another object based on the updating of the object.

11. The system of claim 1, wherein receiving a plurality of operations comprises receiving a first operation from a first source and a second operation from a second source.

12. The system of claim 1, wherein performing an atomic update comprises performing a single operation with respect to the object based on results of the plurality of operations.

13. The system of claim 1, wherein receiving a plurality of operations comprises receiving a first operation directed to the object and a second operation directed to a second object.

14. The system of claim 13, wherein performing an atomic update comprises performing an atomic update of the object and the second object in accordance with the transaction sequence.

15. The system of claim 14, wherein performing an atomic update comprises performing the atomic update of the object and the second object in response to a determination that the atomic update can be performed.

16. The system of claim 1, wherein the object comprises a shared area and an array of transaction identifiers.

17. The system of claim 16, wherein the shared area comprises one or more attributes that remain consistent across multiple versions of the object.

18. The system of claim 16, wherein the array of transaction identifiers comprises one or more pointers to one or more attributes.

19. The system of claim 18, wherein at least one of the attributes corresponds to a previous version of the object.

20. A method comprising:
receiving a plurality of operations directed to an object;
associating the plurality of operations to generate a transaction sequence reflecting that an update associated with a first operation within the transaction sequence affects an update associated with a second operation within the transaction sequence; and
performing an atomic update of the object in accordance with the transaction sequence.

21. The method of claim 20, wherein at least one of the operations adjusts a state of the object.

22. The method of claim 20, wherein at least one of the operations comprises a conditional operation that is dependent upon the state of the object.

23. The method of claim 20, wherein at least one of the operations utilizes a temporary attribute with respect to the object.

24. The method of claim 23, wherein the temporary attribute does not persist with the object after performance of the atomic update.

25. The method of claim 20, wherein performance of at least one of the operations is dependent upon a state of the object.

26. The method of claim 20, further comprising updating a state of another object based on the updating of the object.

27. The method of claim 20, wherein receiving a plurality of operations comprises receiving a first operation from a first source and a second operation from a second source.

28. The method of claim 20, wherein performing an atomic update comprises performing a single operation with respect to the object based on results of the plurality of operations.

29. The method of claim 20, wherein receiving a plurality of operations comprises receiving a first operation directed to the object and a second operation directed to a second object.

30. The system of claim 29, wherein performing an atomic update comprises performing an atomic update of the object and the second object in accordance with the transaction sequence.

31. The system of claim 30, wherein performing an atomic update comprises performing the atomic update of the object and the second object in response to a determination that the atomic update can be performed.

32. The method of claim 20, wherein the object comprises a shared area and an array of transaction identifiers.

33. The system of claim 32, wherein the shared area comprises one or more attributes that remain consistent across multiple versions of the object.

34. The system of claim 32, wherein the array of transaction identifiers comprises one or more pointers to one or more attributes.

35. A non-transitory computer readable medium having instructions stored thereon that, when executed by a processing device, cause the processing device to perform operations comprising:
receiving a plurality of operations directed to an object;
associating the plurality of operations to generate a transaction sequence reflecting that an update associated with a first operation within the transaction sequence affects an update associated with a second operation within the transaction sequence;
performing an atomic update of the object in accordance with the transaction sequence; and
performing an atomic update of another object in accordance with the transaction sequence and based on the update of the object.
